(19) United States
(12) Patent Application Publication
(10) Pub. No.: US 2007/0213188 A1
(43) Pub. Date: Sep. 13, 2007

(54) Impression wheel assembly for transferring glass substrate, roller unit for impression wheel assembly

(76) Inventor: Lin Yao, Taichung City (TW)

Correspondence Address: CHARLES E. BAXLEY, ESQ., 90 JOHN STREET, THIRD FLOOR, NEW YORK, NY, 10038, US

(21) Appl. No.: 11/372,872

(22) Filed: Mar. 10, 2006

(51) Int. Cl. F16C 13/00

(52) U.S. Cl. 492/16; 492/38; 492/28

(57) ABSTRACT

An impression wheel assembly is disclosed to include a wheel axle fixedly supported between two brackets of a glass substrate conveying system, and an impression wheel formed of a plurality of roller units and pivotally supported on the wheel axle, each roller unit having a roller wheel frame supported on the wheel axle and an elastomeric roller wheel body mounted around the roller wheel frame.

### BACKGROUND OF THE INVENTION

1. Field of the Invention

The present invention relates to a glass substrate transferring apparatus and more specifically, to an impression wheel for use in a glass substrate conveying system.

2. Description of the Related Art

During the fabrication of LCD monitors, glass substrates are delivered by a mechanical conveying system. In such a mechanical conveying system, an impression cylinder is provided to impart a proper downward pressure to each glass substrate being delivered so that each glass substrate is smoothly delivered to the assigned place.

FIG. 1 shows a conventional impression cylinder for the aforesaid purpose. According to this design, the impression cylinder comprises a wheel axle 11 fixedly connected between two brackets 12, and a cylindrical wheel body 10 pivotally mounted on the wheel axle 11. The cylindrical wheel body 10 can freely be rotated on the wheel axle 11. When a glass substrate 13 is delivered forwards by a conveying system (not shown) beneath the impression cylinder, the cylindrical wheel body 10 is touched by the moving glass substrate 13 and forced to rotate on the wheel axle 11. In order to prevent damage to the surface of the cylindrical wheel body and the surface of the glass substrate, the cylindrical wheel body 10 is preferably made of rubber, for example, EPDM (Ethylene propylene non-conjugated diene rubber).

The aforesaid cylindrical wheel body 10 wears quickly with use. When the cylindrical wheel body 10 starts to wear, it cannot give a pressure to the whole surface of the glass substrate 13 in a balanced status. Giving an uneven pressure to the glass substrate affects delivery stability. Therefore, when the cylindrical wheel body 10 starts to wear, the cylindrical wheel body 10 must be immediately replaced. It is not economic to frequently replace the cylindrical wheel body of the impression cylinder. It causes a waste to throw away a cylindrical wheel body that has only a small local damage.

### SUMMARY OF THE INVENTION

The present invention has been accomplished under the circumstances in view. It is the main object of the present invention to provide an impression wheel assembly for transferring glass substrates, which allows replacement of every part thereof that starts to wear. It is another object of the present invention to provide an impression wheel assembly, which does not damage the surface of the glass substrate being delivered. To achieve these and other objects of the present invention, the impression wheel assembly comprises a wheel axle fixedly supported between two brackets of a glass substrate conveying system, and an impression wheel supported on said wheel axle. The impression wheel is comprised of a plurality of roller units mounted on the wheel axle and connected to one another. Each roller unit is comprised of a roller wheel frame and a roller wheel body mounted around the roller wheel frame. The roller wheel frame comprises a hub, a rim concentrically spaced around the hub, and a plurality of spokes equiangularly and radially connected between the hub and the rim. The rim has an annular mounting groove extending around the periphery thereof for supporting the associating roller wheel body. The roller wheel body has an outer diameter greater than the outer diameter of the rim so that the periphery of the roller wheel body configures a glass substrate contact surface. When the roller wheel body of one roller unit starts to wear, the user can replace the damaged roller wheel body without changing the whole impression wheel. Further, the roller wheel body covers the peripheral edge of the rim so that the roller wheel frame of each roller unit is prohibited from touching each glass substrate being delivered.

### BRIEF DESCRIPTION OF THE DRAWINGS

FIG. 1 is a schematic drawing showing the arrangement of an impression cylinder according to the prior art.

FIG. 2 is an exploded view of a roller unit for an impression wheel assembly according to the present invention.

FIG. 3 is an elevational assembly view of the roller unit for an impression wheel assembly when viewed obliquely from the left side according to the present invention.

FIG. 4 is an elevational assembly view of the roller unit for an impression wheel assembly when viewed obliquely from the right side according to the present invention.

FIG. 5 is a schematic drawing the structure of an impression wheel assembly according to the present invention.

FIG. 6 is a sectional view of the impression wheel assembly according to the present invention.

FIG. 7 is a sectional view of an alternate form of the impression wheel assembly according to the present invention.

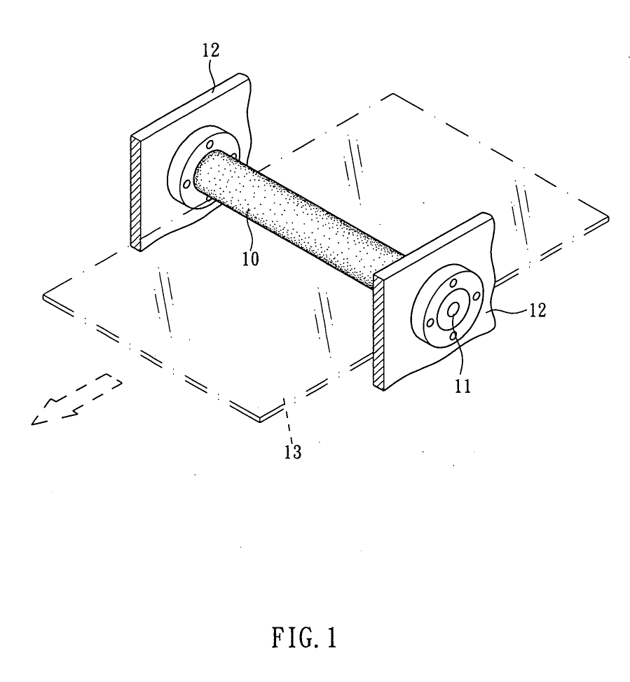

### DETAILED DESCRIPTION OF THE INVENTION

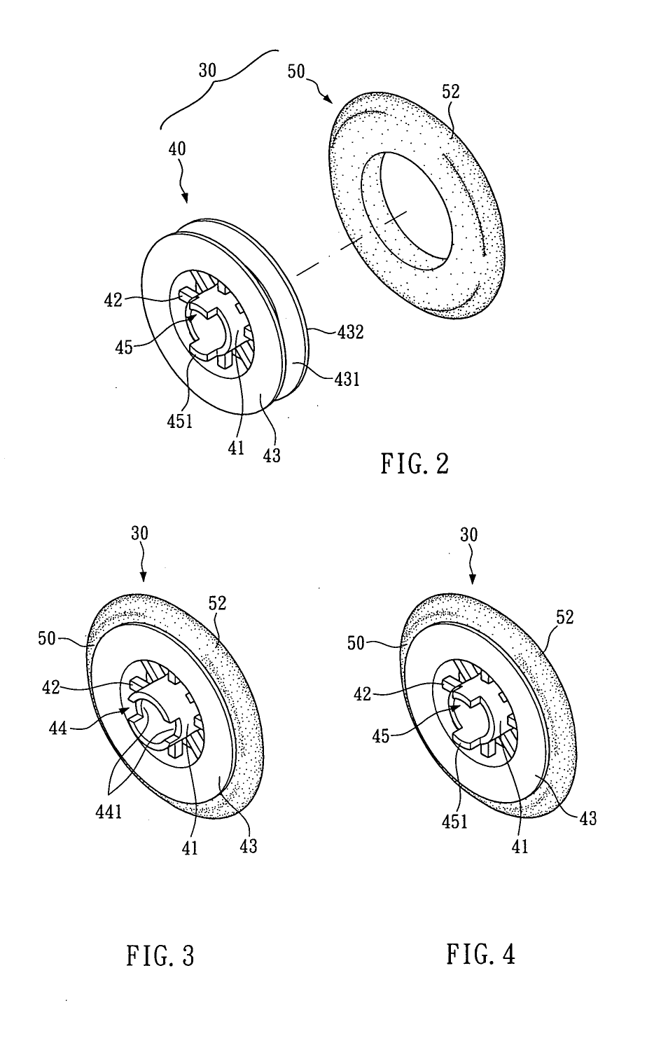

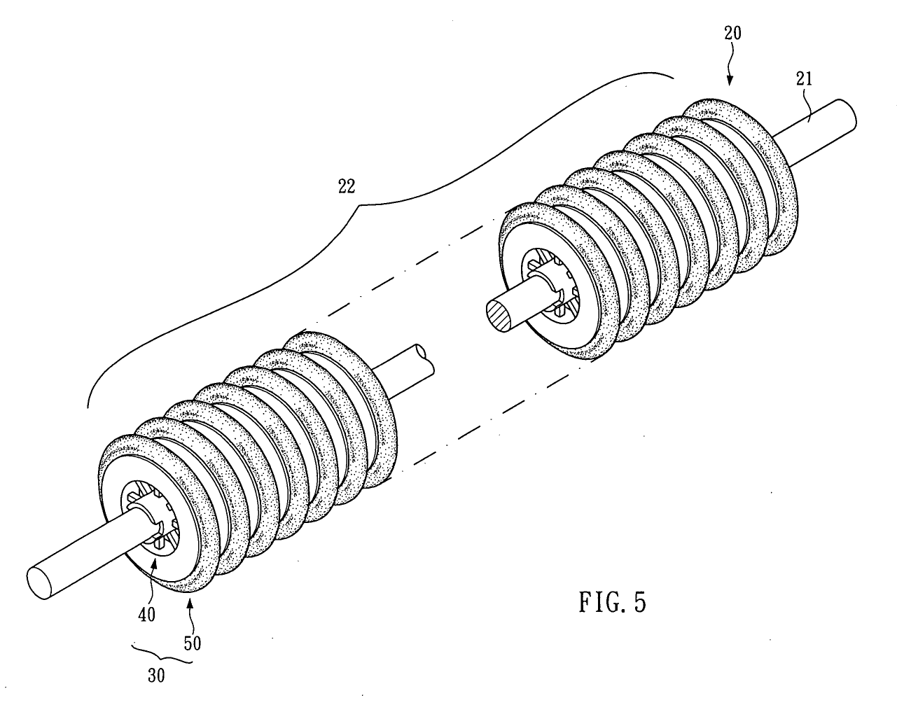

Referring to FIGS. 2˜6, an impression wheel assembly 20 in accordance with the present invention is shown comprised of a wheel axle 21 and an impression wheel 22. The impression wheel 22 is supported on the wheel axle 21. The impression wheel 22 is formed of a plurality of roller units 30 arranged in parallel and abutted one against another.

Each roller unit 30 comprises a roller wheel frame 40, and a roller wheel body 50 mounted on the roller wheel frame 40. The roller wheel frame 40 comprises a hub 41, a rim 43 concentrically spaced around the hub 41, and a plurality of spokes 42 equiangularly and radially connected between the hub 41 and the rim 43. The rim 43 has two sidewalls 432 arranged in parallel, and an annular mounting groove 431 extending around the periphery. The hub 41 has a first coupling structure 44 at one end, namely, the first end, and a second coupling structure 45 at the other end, namely, the second end. The first coupling structure 44 is comprised of two coupling notches 441 symmetrically formed on the first end of the hub 41 at two sides. The second coupling structure 45 is comprised of two coupling lugs 451 symmetrically formed on the second end of the hub 41.

The roller wheel body 50 is an annular member molded from an elastomeric material, for example, PU (polyurethane). The inner diameter A of the roller wheel body 50 is equal to or slightly smaller than the diameter B of the bottom wall of the annular mounting groove 431 of the rim 43. The outer diameter C of the roller wheel body 50 is greater than the outer diameter D of the rim 43. The periphery of the roller wheel body 50 configures a glass substrate contact surface 52 that has a smoothly arched contour. The width E of the roller wheel body 50 is not less than the width F of the annular mounting groove 431 of the rim 43.

The roller wheel body 50 is mounted in the annular mounting groove 431 of the rim 43. Because of the elastomeric material property and the feature that the inner diameter A of the roller wheel body 50 is equal to or slightly smaller than the diameter B of the bottom wall of the annular mounting groove 431 of the rim 43, the roller wheel body 50 is firmly secured to the annular mounting groove 431 of the rim 43 between the two sidewalls 432. Because the outer diameter C of the roller wheel body 50 is greater than the outer diameter D of the rim 43, the glass substrate contact surface 52 of the roller wheel body 50 protrudes over the rim 43 of the roller wheel frame 40.

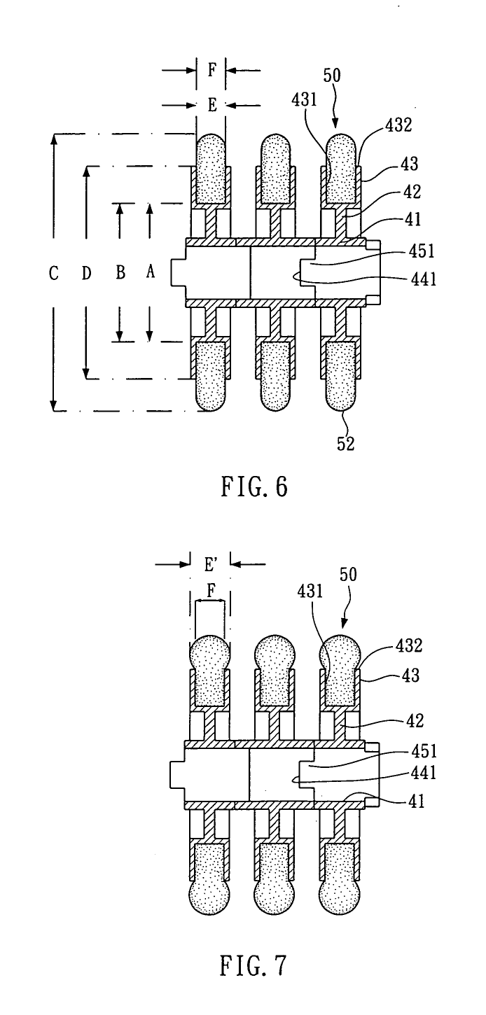

Referring to FIG. 5 and FIG. 6 again, by means of coupling the first coupling structure 44 of one roller unit 30 to the second coupling structure 45 of another roller unit 30, a number of roller units 30 are joined together, forming the desired impression wheel 22. The aforesaid wheel axle 21 is inserted through the hub 41 of each roller unit 30 of the impression wheel 22. Because the roller units 30 of the impression wheel 22 are joined together, rotating one roller unit 30 causes synchronous rotation of the other roller units 30. Similar to conventional design, the wheel axle 21 is fixedly supported between two brackets of a glass substrate conveying system (not shown).

When a glass substrate is moved over the bottom side of the impression wheel 22, the glass substrate contact surface 52 of the roller wheel body 50 of each roller unit 30 is forced into contact with the surface of the glass substrate, enabling the glass substrate to be moved smoothly forwards. Because the roller wheel body 50 is made of an elastomeric material and the glass substrate contact surface 52 has a smoothly arched contour, the roller wheel body 50 does not cause any damage the surface of the glass substrate.

In case the impression wheel 22 starts to wear after a long use, the user can detach the damaged roller wheel body 50 from the associating roller wheel frame 40 of the associating roller unit 30 for a replacement without changing the whole impression wheel.

FIG. 7 shows an alternate form of the present invention. This embodiment is substantially similar to the aforesaid first embodiment with the exception that the width E′ of the roller wheel body 50 according to this second embodiment is greater than the width F of the annular mounting groove 431 of the rim 43 so that the roller wheel body 50 covers the peripheral edge 432 of the rim 43.

Glass substrates of different thicknesses may be used for making different products. The gap between the conveying system and the impression cylinder 22 must allow pass of glass substrates of the smallest thickness, and the roller wheel body 50 is slightly compressed when touching the surface of a glass substrate of the smallest thickness. Because the roller wheel body 50 is made of an elastomeric material, glass substrates of different thicknesses within a certain range can be moved through the gap between the conveying system and the impression wheel 22 over the bottom side of the roller wheel body 50 of each roller unit 30. When a relatively thicker glass substrate is moved over the bottom side of the roller wheel body 50 of each roller unit 30, the roller wheel body 50 will be compressed relatively heavily. Because the roller wheel body 50 covers the peripheral edge 432 of the associating rim 43, the rim 43 of each roller unit 30 is prohibited from touching the glass substrate being delivered over the bottom side of the impression wheel 22. Therefore, the invention prevents the rim 43 of each roller unit 30 from scratching the surface of the moving glass substrate.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An impression wheel assembly used in a glass substrate conveying system, comprising a wheel axle fixedly supported between two brackets, and an impression wheel supported on said wheel axle, wherein said impression wheel is comprised of a plurality of roller units mounted on said wheel axle and connected to one another.

2. The impression wheel assembly as claimed in claim 1, wherein said roller units each comprise a roller wheel frame and a roller wheel body mounted around said roller wheel frame.

3. The impression wheel assembly as claimed in claim 2, wherein said roller wheel frame comprises a hub, a rim concentrically spaced around said hub, and a plurality of spokes equiangularly and radially connected between said hub and said rim, said rim having an annular mounting groove extending around the periphery thereof for supporting the associating roller wheel body.

4. The impression wheel assembly as claimed in claim 3, wherein said hub has a first coupling structure at a first end thereof and a second coupling structure at a second end thereof, the first coupling structure of one of said roller units being connected to the second coupling structure of another of said roller units.

5. The impression wheel assembly as claimed in claim 4, wherein said first coupling structure is comprised of a plurality of coupling notches symmetrically formed on the first end of said hub; said second coupling structure is comprised of a plurality of coupling lugs symmetrically formed on the second end of said hub.

6. The impression wheel assembly as claimed in claim 3, wherein said roller wheel body is an annular member having an outer diameter greater than the outer diameter of said rim.

7. The impression wheel assembly as claimed in claim 6, wherein said roller wheel body has a glass substrate contact surface on the periphery thereof for the contact of each glass substrate being delivered on said conveying system.

8. The impression wheel assembly as claimed in claim 7, wherein said glass substrate contact surface has a smoothly arched contour.

9. The impression wheel assembly as claimed in claim 6, wherein said roller wheel body has a width greater than the width of said annular mounting groove of said rim.

10. The impression wheel assembly as claimed in claim 6, wherein said roller wheel body has a width equal to the width of said annular mounting groove of said rim.

11. The impression wheel assembly as claimed in claim 3, wherein the annular mounting groove of said rim has a bottom wall; said roller wheel body has an inner diameter smaller than the outer diameter of the bottom wall of said annular mounting groove of said rim.

12. The impression wheel as claimed in claim 1, wherein said roller wheel body is made of an elastomeric material.

13. The impression wheel assembly as claimed in claim 1, wherein said impression wheel is rotatable on said wheel axle.

14. A roller unit for use in an impression wheel assembly of a glass substrate conveying system, comprising
a roller wheel frame, said roller wheel frame comprising a hub, a rim concentrically spaced around said hub, and a plurality of spokes equiangularly and radially connected between said hub and said rim, said rim having an annular mounting groove extending around the periphery thereof for supporting the associating roller wheel body; and
a roller wheel body made of an elastomeric material and mounted around said roller wheel frame, said roller wheel body having an outer diameter greater than the outer diameter of said rim and a glass substrate contact surface on the periphery thereof for the contact of each glass substrate being delivered on said glass substrate conveying system.

15. The roller unit as claimed in claim 14, wherein said hub has a first coupling structure and a second coupling structure arranged at two ends thereof such that multiple roller units of the same structure are connectable together by coupling the first coupling structure of one roller unit to the second coupling structure of another roller unit.

16. The roller unit as claimed in claim 15, wherein said first coupling structure is comprised of a plurality of coupling notches symmetrically formed on a first end of said hub; said second coupling structure is comprised of a plurality of coupling lugs symmetrically formed on a second end of said hub.

17. The roller unit as claimed in claim 14, wherein said glass substrate contact surface has a smoothly arched contour.

18. The roller unit as claimed in claim 14, wherein said roller wheel body has a width greater than the width of said annular mounting groove of said rim.

19. The roller unit as claimed in claim 14, wherein the annular mounting groove of said rim has a bottom wall; said roller wheel body has an inner diameter smaller than the outer diameter of the bottom wall of said annular mounting groove of said rim.
